(19) United States
(12) Patent Application Publication
(10) Pub. No.: US 2021/0056254 A1
(43) Pub. Date: Feb. 25, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Hayato KINOSHITA, Kanagawa (JP)

(73) Assignee: FUJI XEROX CO., LTD., Tokyo (JP)

(21) Appl. No.: 16/808,592

(22) Filed: Mar. 4, 2020

(30) Foreign Application Priority Data
Aug. 19, 2019 (JP) 2019-149848

(51) Int. Cl. G06F 40/106; G06F 3/0482; G06K 9/62; G06K 9/00; G06F 40/166; G06F 40/114

(52) U.S. Cl. CPC G06F 40/106; G06F 3/0482; G06K 9/6215; G06K 9/00449; H04N 1/00824; G06F 40/114; G06K 2209/27; G06K 2209/01; G06F 40/166

(57) ABSTRACT

An information processing apparatus includes a processor. The processor is configured to perform a process. The process includes disassembling each of multiple first data sets in units of pages if a combination in the first data set is improper. The multiple first data sets are obtained by reading and sorting out multiple document sets each containing multiple pages of documents. The process also includes reassembling an adequate combination as a second data set if a page group obtained as a result of the disassembling includes the adequate combination.

### CROSS-REFERENCE TO RELATED APPLICATIONS

This application is based on and claims priority under 35 USC 119 from Japanese Patent Application No. 2019-149848 filed Aug. 19, 2019.

### BACKGROUND

### (i) Technical Field

The present disclosure relates to information processing apparatuses and non-transitory computer readable media.

### (ii) Related Art

For example, Japanese Unexamined Patent Application Publication No. 2010-61551 discloses an application-document digitalizing system having an image forming apparatus and an information processing apparatus. The image forming apparatus is capable of transmitting application document data generated as a result of scanning an application document. The image forming apparatus includes an application-document-data acquiring unit that acquires application document data obtained as a result of scanning one or more sets of application documents each constituted of one or more pages, and an application-document-data transmitting unit that transmits the application document data acquired by the application-document-data acquiring unit to the information processing apparatus. The image forming apparatus also includes a recognition-result receiving unit that receives a recognition result including segmentation information of the application document data from the information processing apparatus, and a recognition-result display unit that displays the recognition result including the segmentation information of the application document data received by the recognition-result receiving unit. The information processing apparatus includes an application-document-data receiving unit that receives the application document data transmitted from the image forming apparatus, and an image recognition unit that performs predetermined image recognition on the application document data received by the application-document-data receiving unit. The information processing apparatus also includes segmentation-information generating unit that generates segmentation information for segmenting the application document data into application document data for each set in accordance with a recognition result obtained by the image recognition unit, and a recognition-result transmitting unit that transmits the recognition result including the segmentation information generated by the segmentation-information generating unit to the image forming apparatus.

### SUMMARY

Sometimes, a recognition process is performed on a document set having multiple pages by reading the pages consecutively in a one-by-one fashion, and the pages are sorted out into sets as electronic data. In that case, the document set may sometimes have an error, such as a redundant page or a missing page in the document set or a page of a different inscriber or an unknown page mixed in the document set, due to being mishandled by the user. From the document set having such an error, an appropriate data set is not obtainable.

Aspects of non-limiting embodiments of the present disclosure relate to an information processing apparatus and an information processing program with which, if a combination in a data set obtained by reading and sorting out a document set is improper, a data set with a proper combination may be obtained from the data set including the improper combination.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor. The processor is configured to perform a process. The process includes disassembling each of multiple first data sets in units of pages if a combination in the first data set is improper. The multiple first data sets are obtained by reading and sorting out multiple document sets each containing multiple pages of documents. The process also includes reassembling an adequate combination as a second data set if a page group obtained as a result of the disassembling includes the adequate combination.

### BRIEF DESCRIPTION OF THE DRAWINGS

An exemplary embodiment of the present disclosure will be described in detail based on the following figures, wherein:

FIG. 1 illustrates an example of the configuration of an information processing system according to an exemplary embodiment;

FIG. 2 is a block diagram illustrating an example of an electrical configuration of a server apparatus according to the exemplary embodiment;

FIG. 3 is a block diagram illustrating an example of a functional configuration of the server apparatus according to the exemplary embodiment;

FIG. 4 is a flowchart illustrating an example of the flow of a process based on an information processing program according to the exemplary embodiment;

FIG. 5 is a flowchart illustrating an example of the flow of a first-data-set improperness determination process according to the exemplary embodiment;

FIG. 6A is a front view illustrating an example of a UI screen of a first data set containing a redundant page, FIG. 6B is a front view illustrating an example of a UI screen of a first data set with a missing page, FIG. 6C illustrates an example of a UI screen of a first data set containing a page of a different inscriber, and FIG. 6D is a front view illustrating an example of a UI screen of a first data set containing an unknown page;

FIG. 7 is a diagram used for explaining an improperness-folder storing process according to the exemplary embodiment;

FIG. 8 is a diagram used for explaining another improperness-folder storing process according to the exemplary embodiment;

FIG. 9 is a diagram used for explaining another improperness-folder storing process according to the exemplary embodiment;

FIG. 10 is a flowchart illustrating an example of the flow of an improper-page-list displaying process according to the exemplary embodiment;

FIG. 11 is a front view illustrating an example of an improper-page-list screen according to the exemplary embodiment;

FIG. 12 is a front view illustrating an example of the improper-page-list screen in a state where page contents are displayed in an expanded fashion;

FIG. 13 is a front view illustrating an example of the improper-page-list screen displaying a page viewer;

FIG. 14 is a flowchart illustrating another example of the flow of the improper-page-list displaying process according to the exemplary embodiment;

FIG. 15 is a flowchart illustrating an example of the flow of a handwriting-similarity imparting process according to the exemplary embodiment;

FIG. 16 is a diagram used for explaining another example of the improper-page-list displaying process according to the exemplary embodiment;

FIG. 17 is a diagram used for explaining an adequate-page combining process according to the exemplary embodiment;

FIG. 18 is a diagram used for explaining a combined-page-group storing process according to the exemplary embodiment; and

FIG. 19 is a diagram used for explaining another combined-page-group storing process according to the exemplary embodiment.

### DETAILED DESCRIPTION

An exemplary embodiment of the present disclosure will be described in detail below with reference to the drawings.

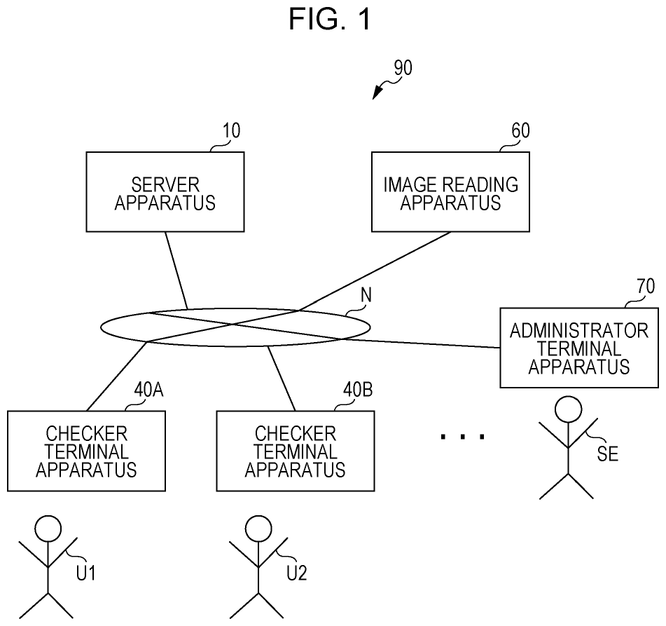

FIG. 1 illustrates an example of the configuration of an information processing system 90 according to this exemplary embodiment.

As shown in FIG. 1, the information processing system 90 according to this exemplary embodiment includes a server apparatus 10, checker terminal apparatuses 40A, 40B, and so on, an image reading apparatus 60, and an administrator terminal apparatus 70. The server apparatus 10 is an example of an information processing apparatus.

The server apparatus 10 is connected to each of the checker terminal apparatuses 40A, 40B, and so on, the image reading apparatus 60, and the administrator terminal apparatus 70 via a network N. The server apparatus 10 is, for example, a general-purpose computer, such as a server computer or a personal computer (PC). The network N is, for example, the Internet, a local area network (LAN), or a wide area network (WAN).

The image reading apparatus 60 has a function of acquiring an image by optically reading, for example, a form formed of a paper medium, and transmitting the acquired image (referred to as “form image” hereinafter) to the server apparatus 10. The form used is, for example, one of various types of forms including multiple items, such as an address field and a name field. With regard to each of these multiple items, for example, handwritten text or printed text is inscribed on this form. As will be described in detail later, the server apparatus 10 performs an optical character recognition (OCR) process on the form image received from the image reading apparatus 60 so as to acquire a recognition result with respect to an image corresponding to each of the multiple items. This recognition result includes, for example, a text string indicating a string of one or more text characters. On the form, a region where text corresponding to an item is inscribable is defined by a frame, and the text inscribable region is defined as a recognition target region. By performing the OCR process on the defined region, a text string with respect to an image corresponding to each of the multiple items is acquired.

The checker terminal apparatus 40A is to be operated by a checker (user) U1 who performs a checking process, and the checker terminal apparatus 40B is to be operated by a checker U2 who performs a checking process. If these multiple checker terminal apparatuses 40A, 40B, and so on are not to be distinguished from one another, the checker terminal apparatuses 40A, 40B, and so on may be collectively referred to as “checker terminal apparatuses 40” hereinafter. Furthermore, if these multiple checkers U1, U2, and so on are not to be distinguished from one another, the checkers U1, U2, and so on may be collectively referred to as “checkers U” hereinafter. The checker terminal apparatuses 40 are, for example, general-purpose computers, such as personal computers (PC), or portable terminal apparatuses, such as smartphones or tablet terminals. Each checker terminal apparatus 40 has a checking-process application program (also referred to as “checking-process application” hereinafter) installed therein and to be used by the corresponding checker U for performing a checking process, and generates and displays a checking-process user interface (UI) screen. The checking process involves checking a recognition result of, for example, text included in a form image or checking and correcting a recognition result.

The administrator terminal apparatus 70 is a terminal apparatus that is to be operated by a system administrator SE and in which form definition data is set via a form definition screen (not shown) by the system administrator SE. The administrator terminal apparatus 70 is, for example, a general-purpose computer, such as a personal computer (PC), or a portable terminal apparatus, such as a smartphone or a tablet terminal.

If a certainty factor of a recognition result obtained by recognizing an image of each item (referred to as “item image” hereinafter) included in a form image is lower than a threshold value, the server apparatus 10 performs a manual checking process. If the certainty factor is higher than the threshold value, the server apparatus 10 outputs the recognition result as a final recognition result without performing a manual checking process.

If the above-described checking process is to be performed, the server apparatus 10 associates the item image with the text string obtained as a result of the OCR process, and performs control for causing the checker terminal apparatus 40 to display the item image and the text string on the UI screen. The checker U checks whether or not the text string corresponding to the item image is correct while viewing the item image. If the check result is correct, the checker U keeps the text string as-is. If the checked result is incorrect, the checker U inputs a correct text string to the UI screen. The checker terminal apparatus 40 transmits the text string input via the UI screen as a check result to the server apparatus 10. Based on the check result from the checker terminal apparatus 40, the server apparatus 10 outputs a final recognition result and performs control for causing the checker terminal apparatus 40 to display the final recognition result on the UI screen.

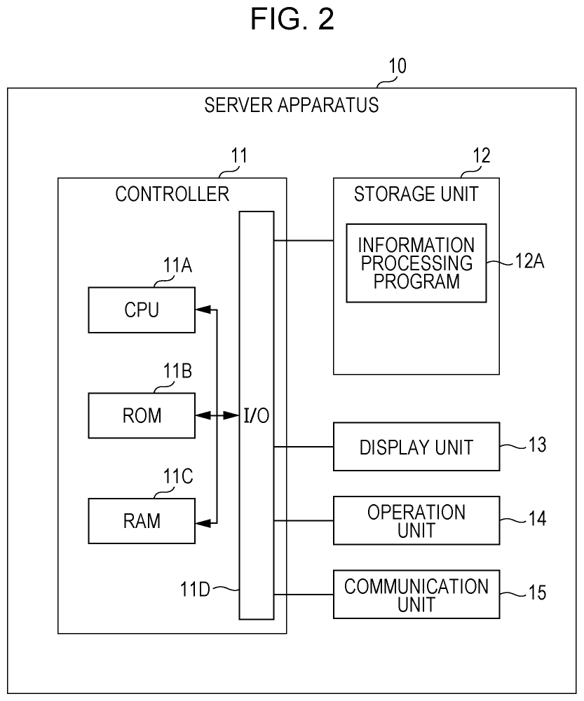

FIG. 2 is a block diagram illustrating an example of an electrical configuration of the server apparatus 10 according to this exemplary embodiment.

As shown in FIG. 2, the server apparatus 10 according to this exemplary embodiment includes a controller 11, a storage unit 12, a display unit 13, an operation unit 14, and a communication unit 15.

The controller 11 includes a central processing unit (CPU) 11A, a read-only memory (ROM) 11B, a random access memory (RAM) 11C, and an input-output interface (I/O) 11D. These units are connected to one another via a bus.

The I/O 11D is connected to functional units including the storage unit 12, the display unit 13, the operation unit 14, and the communication unit 15. These functional units are communicable with the CPU 11A via the I/O 11D.

The controller 11 may serve as a second controller that partially controls the operation of the server apparatus 10, or may serve as a part of a first controller that entirely controls the operation of the server apparatus 10. The blocks of the controller 11 may partially or entirely be, for example, an integrated circuit (IC), such as a large scale integration (LSI) circuit, or an IC chip set. The blocks may be individual circuits or may partially or entirely be an integrated circuit. The blocks may be integrated with each other, or one or some of the blocks may be separately provided. In each of the blocks, a part thereof may be separately provided. The integration of the controller 11 is not limited to LSI and may be a dedicated circuit or a general-purpose processor.

The storage unit 12 is, for example, a hard disk drive (HDD), a solid state drive (SSD), or a flash memory. The storage unit 12 stores therein an information processing program 12A according to this exemplary embodiment. The information processing program 12A may alternatively be stored in the ROM 11B.

The information processing program 12A may be preinstalled in, for example, the server apparatus 10. The information processing program 12A may be realized by being stored in a nonvolatile storage medium or by being distributed via the network N, and by being installed in the server apparatus 10, where appropriate. Examples of the nonvolatile storage medium include a compact disc read-only memory (CD-ROM), a magneto-optical disk, an HDD, a digital versatile disc read-only memory (DVD-ROM), a flash memory, and a memory card.

The display unit 13 is, for example, a liquid crystal display (LCD) or an organic electroluminescence (EL) display. The display unit 13 may integrally have a touchscreen. The operation unit 14 is provided with, for example, an operation input device, such as a keyboard and a mouse. The display unit 13 and the operation unit 14 receive various types of commands from a user of the server apparatus 10. The display unit 13 displays various types of information, such as a result of a process executed in accordance with a command received from the user and a notification about a process.

The communication unit 15 is connected to the network N via the Internet, a LAN, or a WAN, and is communicable with the image reading apparatus 60, the checker terminal apparatuses 40, and the administrator terminal apparatus 70 via the network N.

As mentioned above, sometimes, a recognition process is performed on a document set having multiple pages by reading the pages consecutively in a one-by-one fashion, and the pages are sorted out into sets as electronic data. In that case, the document set may sometimes have an error due to being mishandled by the user. From the document set having such an error, an appropriate data set is not obtainable. The term “document set” used here is defined as a set containing multiple pages of paper documents. The term “data set” used here is defined as a set containing data (read data) of multiple pages obtained by reading the document set and sorting out the pages based on a certain rule. This data set is obtained as a result of sorting out the read data of the pages of the document set based on a recognition result obtained by performing an OCR process on the read data of the pages of the document set.

Although the form mentioned above is described as an example of a document in this exemplary embodiment, the document is not limited to a form and may include, for example, a normal document.

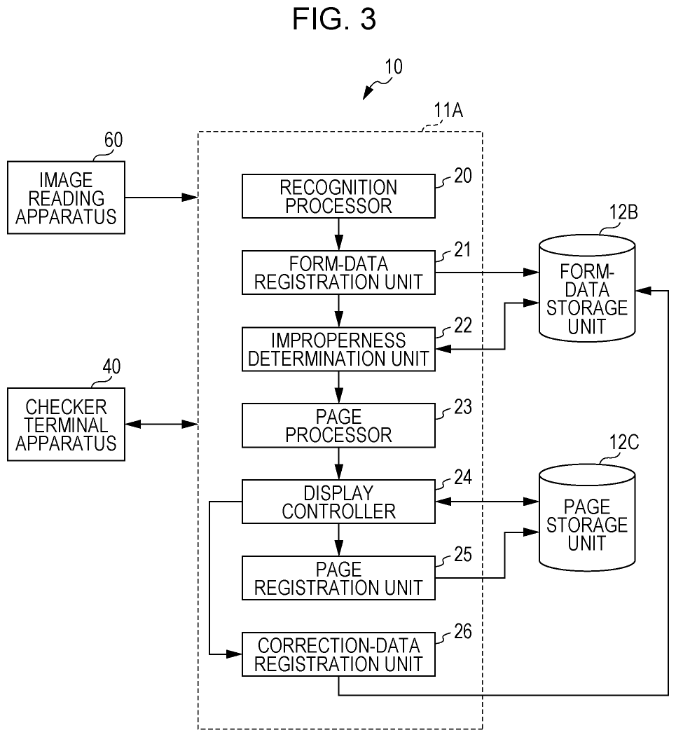

The CPU 11A of the server apparatus 10 according to this exemplary embodiment executes the information processing program 12A stored in the storage unit 12 by loading the information processing program 12A to the RAM 11C, thereby functioning as the units shown in FIG. 3. The CPU 11A is an example of a processor.

FIG. 3 is a block diagram illustrating an example of a functional configuration of the server apparatus 10 according to this exemplary embodiment.

As shown in FIG. 3, the CPU 11A of the server apparatus 10 according to this exemplary embodiment functions as a recognition processor 20, a form-data registration unit 21, an improperness determination unit 22, a page processor 23, a display controller 24, a page registration unit 25, and a correction-data registration unit 26.

The storage unit 12 according to this exemplary embodiment is provided with, for example, a form-data storage unit 12B that stores form data and a page storage unit 12C that stores improper data in units of pages.

The image reading apparatus 60 acquires read data by reading multiple form sets including multiple pages of forms, and transmits the acquired read data to the server apparatus 10.

The recognition processor 20 acquires a recognition result by executing an OCR process on the read data received from the image reading apparatus 60 in accordance with predetermined setting contents of form definition data. In this case, the recognition processor 20 acquires meta-information related to multiple pages of the read data as a result of performing the OCR process. This meta-information is at least one of a form page number, a layout, a specific field, an image patch, a form identification (ID), handwriting, and an inscriber ID. In detail, for example, each page of a form image is given a bar code or a two-dimensional code. By reading the bar code or the two-dimensional code, for example, a form ID, a page number, and an inscriber ID are acquired. A layout is information indicating the page configuration. In the case of the layout, the page configuration is stored in correspondence with the number of pages. A specific field is information indicating the location of the specific field. In the case of the specific field, the location of the specific field is stored in correspondence with the number of pages. An image patch is information indicating a specific image at a specific location. In the case of the image patch, the specific image at the specific location is stored in correspondence with the number of pages. Handwriting is information indicating the handwriting of an inscriber. The recognition processor 20 outputs the recognition result and the meta-information in correspondence with the read data.

The form-data registration unit 21 sorts out the read data, corresponding to the recognition result and the meta-information and output from the recognition processor 20, based on the recognition result. Each sorted piece of the read data is defined as a first data set. For example, it is assumed that A-1/3, A-2/3, A-3/3, B-1/3, and B-2/3 are obtained as recognition results of multiple form sets. A and B denote form IDs, and 1/3 to 3/3 denote page numbers. In this case, the read data is sorted into two first data sets, namely, an A set 1/3 to 3/3 and a B set 1/3 to 2/3. The form-data registration unit 21 stores the multiple first data sets obtained as a result of sorting out the read data into the form-data storage unit 12B.

The improperness determination unit 22 determines whether or not a combination in each of the multiple first data sets stored in the form-data storage unit 12B is improper by using the meta-information. For example, in the example of the A set and the B set mentioned above, the A set is determined as being adequate since 1/3 to 3/3 are all available, whereas the B set is determined as being improper since 3/3 is missing.

If the combination in each of the multiple first data sets is improper based on the determination result obtained by the improperness determination unit 22, the page processor 23 disassembles each first data set in units of pages. If a page group obtained as a result of the disassembling includes an adequate combination, the page processor 23 performs a process for reassembling the adequate page combination as a second data set. The expression “disassembles each first data set in units of pages” implies that a file of a first data set is disassembled into multiple pages. The expression “reassembling the adequate page combination as a second data set” implies that the adequate page combination is made into a file of the second data set.

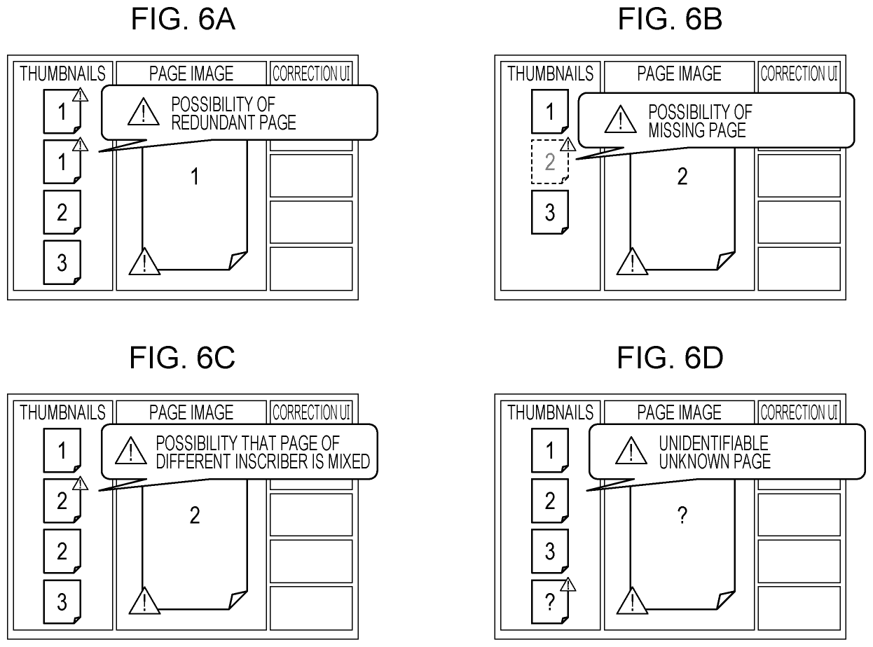

The display controller 24 performs control for displaying the multiple pages obtained as a result of the page processor 23 disassembling the first data set and for displaying information indicating the cause of improperness of the first data set, for example, as shown in FIGS. 6A to 6D to be described later. The cause in this case is at least one of a missing page in the first data set and an excess page included in the first data set. An excess page is, for example, any one of a redundant page, a page of a different inscriber, and an unknown page.

If there is a page missing from the first data set, the page registration unit 25 stores the multiple pages of the first data set into a predetermined folder (referred to as “improperness folder” hereinafter). This improperness folder is provided in the page storage unit 12C. Furthermore, if there is an excess page included in the first data set, the page registration unit 25 stores the excess page in the improperness folder. In this case, the page processor 23 performs a process for reassembling the remaining page or pages excluding the excess page deleted from the first data set as a second data set.

Each of the pages of page groups stored in the improperness folder is given meta-information. For example, the page processor 23 performs a process of using the meta-information given to each of the pages of page groups to identify an adequate combination from the page groups. The display controller 24 performs control for displaying the adequate combination identified by the page processor 23 as a second data set in an identifiable manner. In this case, if any of the pages in the second data set is selected, the display controller 24 may perform control for displaying information indicating the content of the selected page in an expanded fashion.

Based on the meta-information of the page selected from a list of the page groups stored in the improperness folder, the page processor 23 may perform a process for searching through the page groups for a candidate for an adequate combination. In this case, the display controller 24 performs control for displaying the candidate for an adequate combination found by the page processor 23 in an identifiable manner. When displaying the candidate for an adequate combination in an identifiable manner, the display controller 24 may perform display control such that the meta-information used in the search for the pages serving as the candidate for an adequate combination is given to each of the pages. Moreover, the page processor 23 may perform a process for deriving a handwriting similarity indicating a similarity between the handwriting on the page selected from the list of the page groups and the handwriting on another page. For deriving the handwriting similarity, a known method is used in which the possibility of the handwriting being identical increases with increasing handwriting similarity (indicated with, for example, %). In this case, the display controller 24 may perform control for displaying levels of handwriting similarity for pages serving as candidates for adequate combinations in an identifiable manner.

The correction-data registration unit 26 stores corrected data, obtained as a result of correcting a page group stored in the improperness folder, into the form-data storage unit 12B.

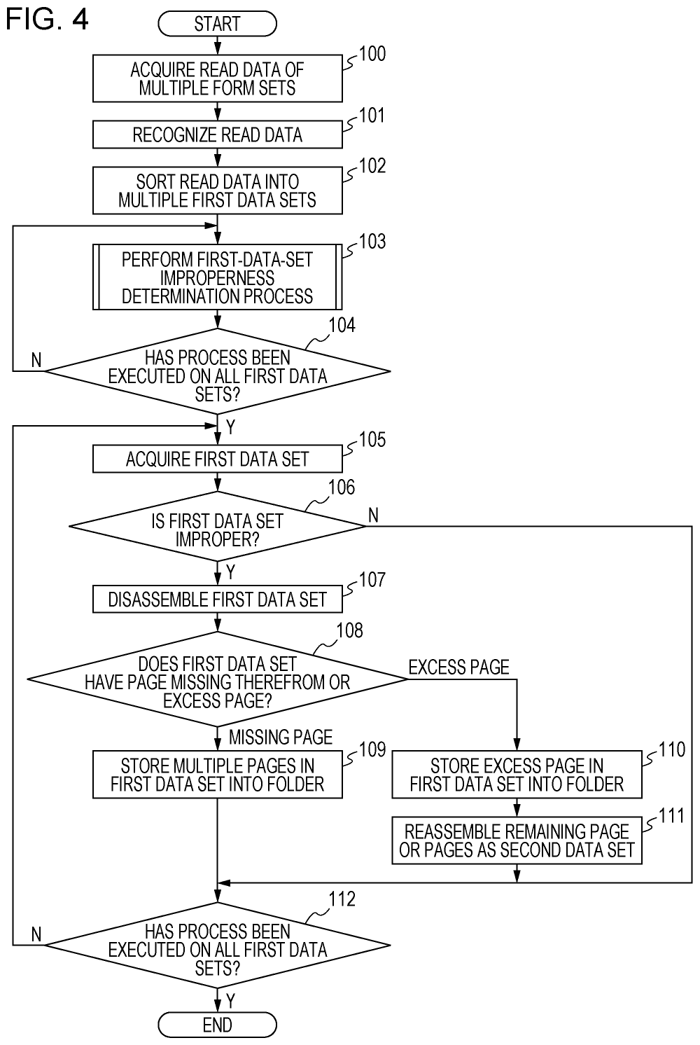

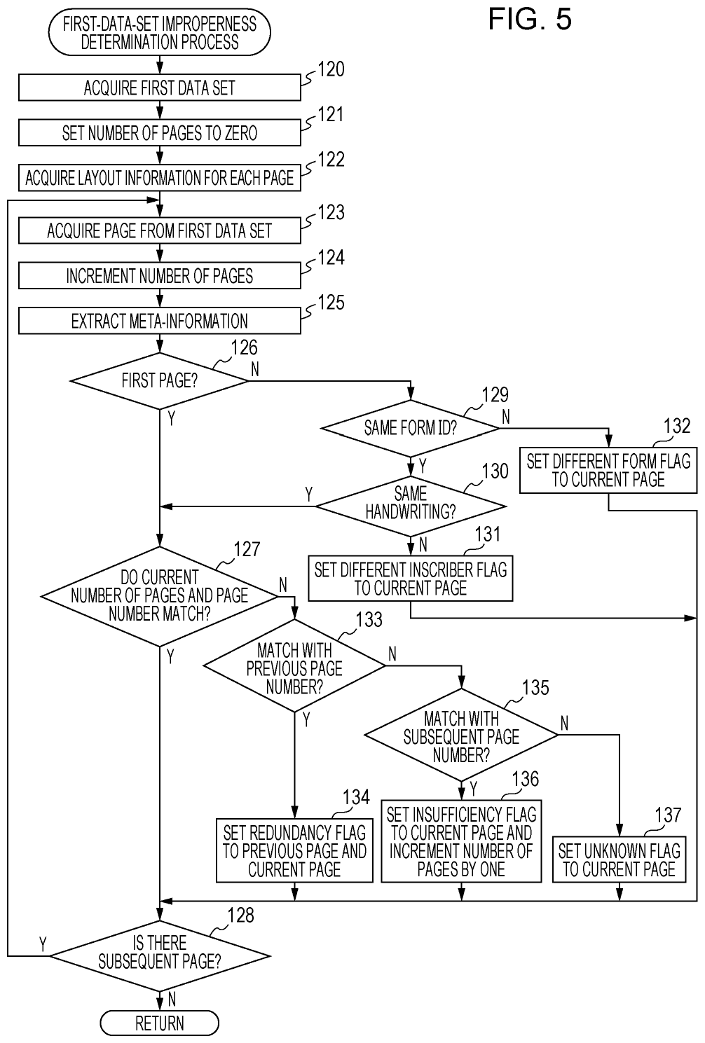

Next, the operation of the server apparatus 10 according to this exemplary embodiment will be described with reference to FIGS. 4 and 5.

FIG. 4 is a flowchart illustrating an example of the flow of a process based on the information processing program 12A according to this exemplary embodiment.

First, when the server apparatus 10 is commanded to execute an OCR process, the CPU 11A activates the information processing program 12A to execute the following steps.

In step 100 in FIG. 4, the CPU 11A acquires read data of multiple form sets from the image reading apparatus 60.

In step 101, the CPU 11A performs an OCR process on the read data acquired in step 100 so as to acquire a recognition result. In this case, meta-information is also acquired in accordance with the OCR process. As mentioned above, meta-information is at least one of a form page number, a layout, a specific field, an image patch, a form ID, handwriting, and an inscriber ID.

In step 102, the CPU 11A sorts out the read data into multiple first data sets based on the recognition result acquired in step 101, and stores the sorted first data sets into the form-data storage unit 12B.

In step 103, the CPU 11A executes an improperness determination process on each of the multiple first data sets sorted in step 102.

FIG. 5 is a flowchart illustrating an example of the flow of the first-data-set improperness determination process according to this exemplary embodiment.

In step 120 in FIG. 5, the CPU 11A acquires a first data set from the form-data storage unit 12B.

In step 121, the CPU 11A sets the number of pages in the first data set acquired in step 120 to zero.

In step 122, the CPU 11A acquires layout information of each page of the first data set.

In step 123, the CPU 11A acquires a page (referred to as “current page” hereinafter) from the first data set.

In step 124, the CPU 11A increments the number of pages in the first data set.

In step 125, the CPU 11A extracts meta-information of the current page acquired in step 123.

In step 126, the CPU 11A determines whether or not the current page acquired in step 123 is the first page based on the meta-information extracted in step 125. If it is determined that the current page is the first page (i.e., if a positive determination result is obtained), the process proceeds to step 127. If it is determined that the current page is not the first page (i.e., if a negative determination result is obtained), the process proceeds to step 129.

In step 127, the CPU 11A determines whether or not the current number of pages and the page number match. If it is determined that the current number of pages and the page number match (i.e., if a positive determination result is obtained), the process proceeds to step 128. If it is determined that the current number of pages and the page number do not match (i.e., if a negative determination result is obtained), the process proceeds to step 133.

In step 128, the CPU 11A determines whether or not the first data set has a subsequent page. If it is determined that the first data set has a subsequent page (i.e., if a positive determination result is obtained), the process proceeds to step 123. If it is determined that the first data set does not have a subsequent page (i.e., if a negative determination result is obtained), the process returns to step 104 in FIG. 4.

In step 129, the CPU 11A determines whether or not the form ID of the current page and the form ID of the first page are the same. If it is determined that the form ID of the current page and the form ID of the first page are the same (i.e., if a positive determination result is obtained), the process proceeds to step 130. If it determined that the form ID of the current page and the form ID of the first page are not the same (i.e., if a negative determination result is obtained), the process proceeds to step 132.

In step 130, the CPU 11A determines whether or not the handwriting on the current page and the handwriting on the first page are the same. For the handwriting determination, a known technique is used, but the technique is not particularly limited. If it is determined that the handwriting on the current page and the handwriting on the first page are the same (i.e., if a positive determination result is obtained), the process proceeds to step 127. If it is determined that the handwriting on the current page and the handwriting on the first page are not the same (i.e., if a negative determination result is obtained), the process proceeds to step 131.

In step 131, the CPU 11A sets a different inscriber flag to the current page, and proceeds to step 128.

In step 132, the CPU 11A sets a different form flag to the current page, and proceeds to step 128.

In step 133, the CPU 11A determines whether or not the current number of pages and the previous page number match. If it is determined that the current number of pages and the previous page number match (i.e., if a positive determination result is obtained), the process proceeds to step 134. If it is determined that the current number of pages and the previous page number do not match (i.e., if a negative determination result is obtained), the process proceeds to step 135.

In step 134, the CPU 11A sets a redundancy flag to the previous page and the current page, and proceeds to step 128.

In step 135, the CPU 11A determines whether or not the current number of pages and the subsequent page number match. If it is determined that the current number of pages and the subsequent page number match (i.e., if a positive determination result is obtained), the process proceeds to step 136. If it is determined that the current number of pages and the subsequent page number do not match (i.e., if a negative determination result is obtained), the process proceeds to step 137.

In step 136, the CPU 11A sets an insufficiency flag to the current page, increments the number of pages by one, and proceeds to step 128.

In step 137, the CPU 11A sets an unknown flag to the current page, and proceeds to step 128.

Referring back to FIG. 4, in step 104, the CPU 11A determines whether or not the process has been executed on all of the first data sets. If it is determined that the process has been executed on all of the first data sets (i.e., if a positive determination result is obtained), the process proceeds to step 105. If it is determined that the process has not been executed on all of the first data sets (i.e., if a negative determination result is obtained), the process returns to step 103 and is repeated thereafter.

In step 105, the CPU 11A acquires a first data set.

In step 106, the CPU 11A determines whether or not the first data set acquired in step 105 is improper. If it is determined that the first data set is improper (i.e., if a positive determination result is obtained), the process proceeds to step 107. If it is determined that the first data set is not improper, that is, if it is determined that the first data set is adequate (i.e., if a negative determination result is obtained), the process proceeds to step 112.

In step 107, the CPU 11A disassembles the first data set in units of pages, and performs control for displaying the first data set disassembled in units of pages on, for example, the checker terminal apparatus 40. In detail, as illustrated in FIGS. 6A to 6D, for example, the control involves displaying multiple pages obtained as a result of disassembling the first data set and also displaying information indicating the cause of improperness of the first data set.

FIG. 6A is a front view illustrating an example of a UI screen of a first data set containing a redundant page. FIG. 6B is a front view illustrating an example of a UI screen of a first data set with a missing page. FIG. 6C illustrates an example of a UI screen of a first data set containing a page of a different inscriber. FIG. 6D is a front view illustrating an example of a UI screen of a first data set containing an unknown page.

In the example in FIG. 6A, since there is a possibility that page 1 is redundant, a message indicating “possibility of redundant page” is displayed. In the example in FIG. 6B, since there is a possibility that page 2 is missing, a message indicating “possibility of missing page” is displayed. In the example in FIG. 6C, since there is a possibility that page 2 is a page of a different inscriber, a message indicating “possibility that page of different inscriber is mixed” is displayed. In the example in FIG. 6D, since there is a possibility that an unknown page is included, a message indicating “unidentifiable unknown page” is displayed.

In step 108, the CPU 11A determines whether the first data set has a page missing therefrom or the first data set contains an excess page. As mentioned above, an excess page is any one of a redundant page, a page of a different inscriber, and an unknown page. If it is determined that the first data set has a page missing therefrom (i.e., in the case of a missing page), the process proceeds to step 109. If it is determined that the first data set contains an excess page (i.e., in the case of an excess page), the process proceeds to step 110.

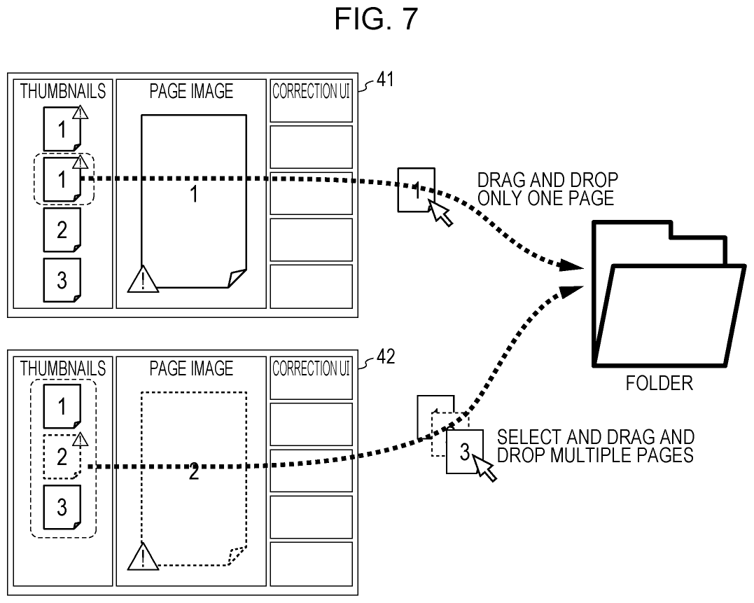

In step 109, the CPU 11A stores the multiple pages of the first data set into the improperness folder, for example, as shown in FIGS. 7 to 9 to be described later.

In contrast, in step 110, the CPU 11A stores only the excess page of the first data set into the improperness folder, for example, as shown in FIGS. 7 to 9 to be described later.

In step 111, the CPU 11A reassembles the remaining page or pages excluding the excess page removed from the first data set as an adequate second data set.

In step 112, the CPU 11A determines whether or not the process has been executed on all of the first data sets. If it is determined that the process has not been executed on all of the first data sets (i.e., if a negative determination result is obtained), the process proceeds to step 105. If it is determined that the process has been executed on all of the first data sets (i.e., if a positive determination result is obtained), the sequential process based on the information processing program 12A ends.

Next, a process for storing an improper page or pages of a first data set into the improperness folder (referred to as “improperness-folder storing process” hereinafter) will be described in detail with reference to FIGS. 7 to 9.

FIG. 7 is a diagram used for explaining the improperness-folder storing process according to this exemplary embodiment.

A UI screen 41 and a UI screen 42 in FIG. 7 are each displayed on the checker terminal apparatus 40. On the UI screen 41, a first data set containing a redundant page (i.e., page 1 in this case) is displayed. On the UI screen 41, a thumbnail image of the redundant page (page 1) in the first data set is stored into the improperness folder in accordance with a drag-and-drop operation. On the UI screen 42, a first data set with a missing page (i.e., page 2 in this case) is displayed. On the UI screen 42, thumbnail images of multiple pages (i.e., page 1 and page 3 in this case) in the first data set with the missing page (page 2) are stored into the improperness folder in accordance with a drag-and-drop operation.

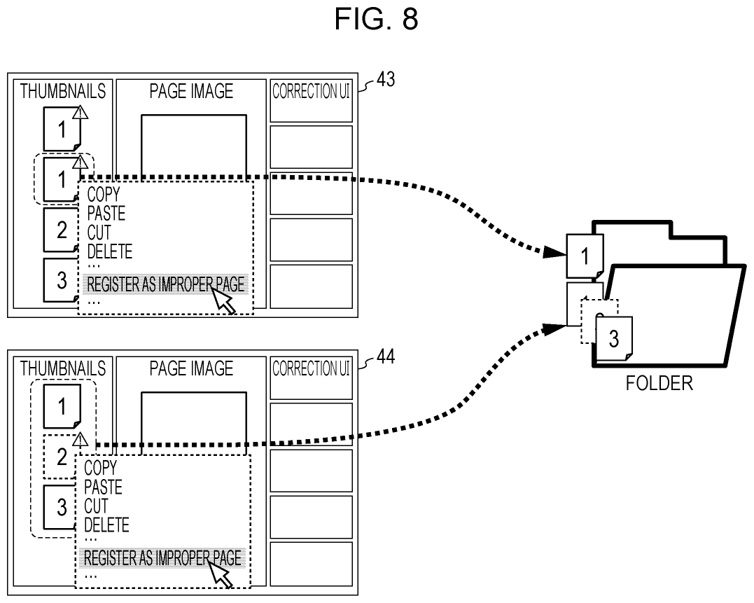

FIG. 8 is a diagram used for explaining another improperness-folder storing process according to this exemplary embodiment.

A UI screen 43 and a UI screen 44 in FIG. 8 are each displayed on the checker terminal apparatus 40. On the UI screen 43, a first data set containing a redundant page (i.e., page 1 in this case) is displayed. On the UI screen 43, the redundant page (page 1) in the first data set is selected, and an option “register as improper page” in a right-click menu of a thumbnail image is selectively operated, so that the thumbnail image of the redundant page (page 1) is stored into the improperness folder. On the UI screen 44, a first data set with a missing page (i.e., page 2 in this case) is displayed. On the UI screen 44, multiple pages (i.e., page 1 and page 3 in this case) in the first data set are selected, and an option “register as improper page” in a right-click menu of thumbnail images is selectively operated, so that the thumbnail images of the multiple pages (page 1 and page 3) are stored into the improperness folder.

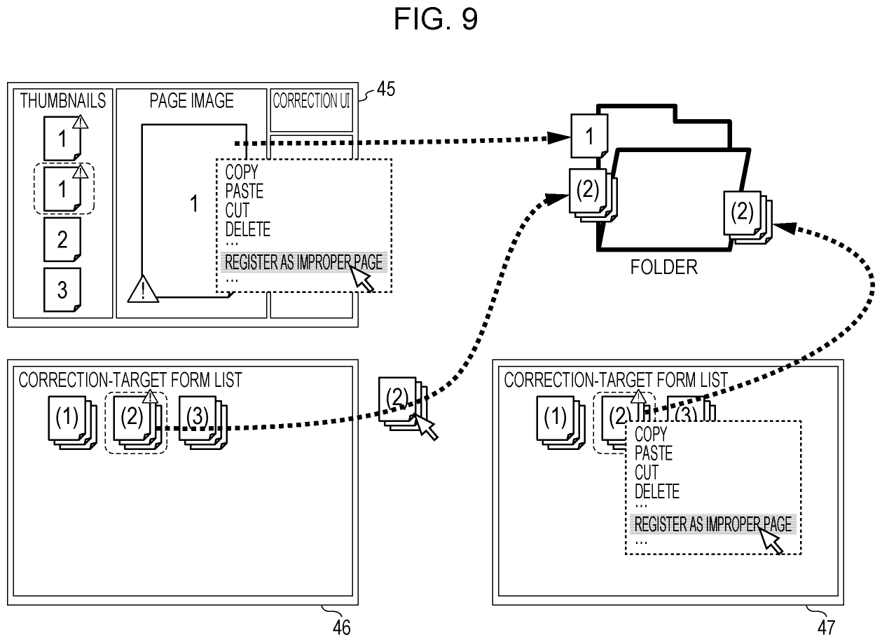

FIG. 9 is a diagram used for explaining another improperness-folder storing process according to this exemplary embodiment.

A UI screen 45, a UI screen 46, and a UI screen 47 in FIG. 9 are each displayed on the checker terminal apparatus 40. On the UI screen 45, a first data set containing a redundant page (i.e., page 1 in this case) is displayed. On the UI screen 45, an option “register as improper page” in a right-click menu of a page image of the redundant page (page 1) is selectively operated instead of a thumbnail image of the redundant page (page 1), so that the page image of the redundant page (page 1) is stored into the improperness folder. On the UI screen 46, a correction-target form list is displayed. On the UI screen 46, a thumbnail image group of specific pages selected from the correction-target form list is stored into the improperness folder in accordance with a drag-and-drop operation. On the UI screen 47, a correction-target form list is similarly displayed. On the UI screen 47, a thumbnail image group of specific pages is selected from the correction-target form list, and an option “register as improper page” in a right-click menu is selectively operated, so that the thumbnail image group of the specific pages is stored into the improperness folder.

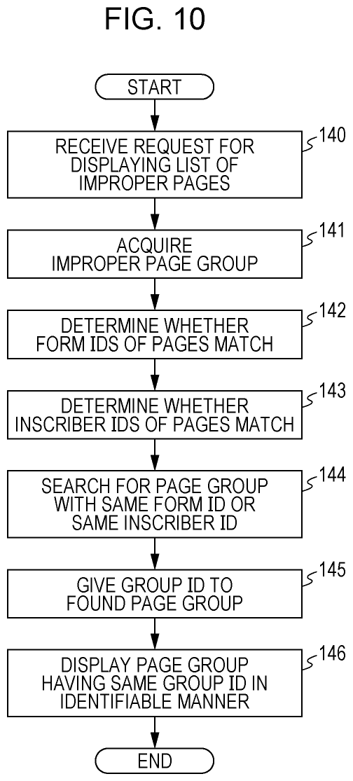

Next, a process for displaying a list of page groups stored in the improperness folder (referred to as “improper-page-list displaying process” hereinafter) will be described with reference to FIG. 10.

FIG. 10 is a flowchart illustrating an example of the flow of the improper-page-list displaying process according to this exemplary embodiment.

First, when the server apparatus 10 is commanded to execute the improper-page-list displaying process, the CPU 11A activates the information processing program 12A to execute the following steps.

In step 140 in FIG. 10, the CPU 11A performs control for receiving a request for displaying a list of improper pages from the checker terminal apparatus 40.

In step 141, the CPU 11A acquires an improper page group from the improperness folder.

In step 142, the CPU 11A determines whether form IDs of the pages match with respect to the improper page group acquired in step 141.

In step 143, the CPU 11A determines whether inscriber IDs of the pages match with respect to the improper page group acquired in step 141.

In step 144, the CPU 11A searches for a page group with the same form ID or the same inscriber ID.

In step 145, the CPU 11A gives a group ID to the page group obtained as a result of the search in step 144.

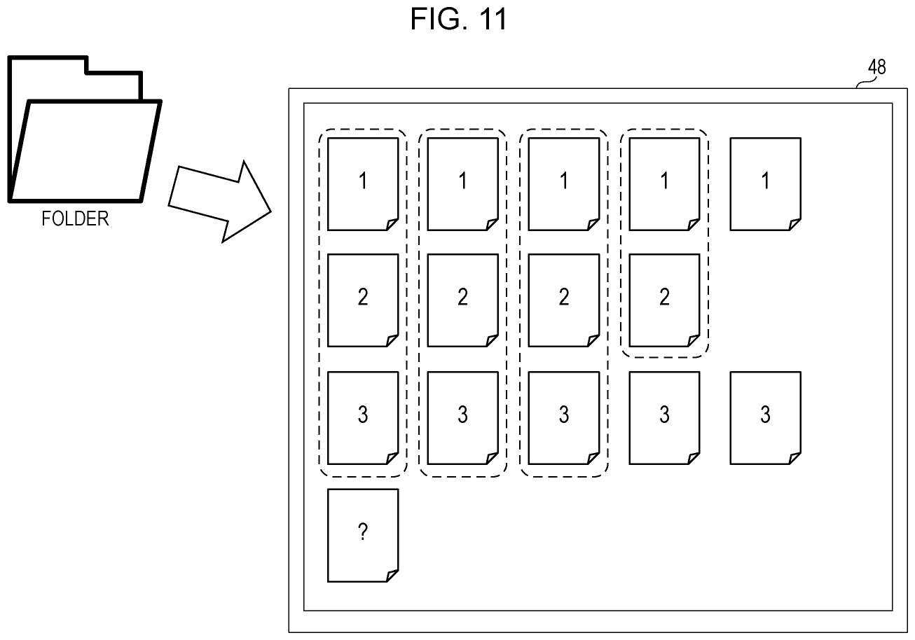

In step 146, the CPU 11A performs control for displaying the page group having the same group ID, given thereto in step 145, in an identifiable manner on the checker terminal apparatus 40, as shown in FIG. 11 as an example. The improper-page-list displaying process then ends.

FIG. 11 is a front view illustrating an example of an improper-page-list screen 48 according to this exemplary embodiment.

The improper-page-list screen 48 shown in FIG. 11 is displayed on the checker terminal apparatus 40. On this improper-page-list screen 48, each page group having the same group ID is displayed by being surrounded by a dotted frame. Each page group surrounded by a dotted frame is defined as a second data set. Although dotted frames are used in the example in FIG. 11, any display mode may be used so long as combinations of adequate pages are identifiable, such as a display mode using different colors, a display mode using different hatching patterns, or a display mode using different sizes.

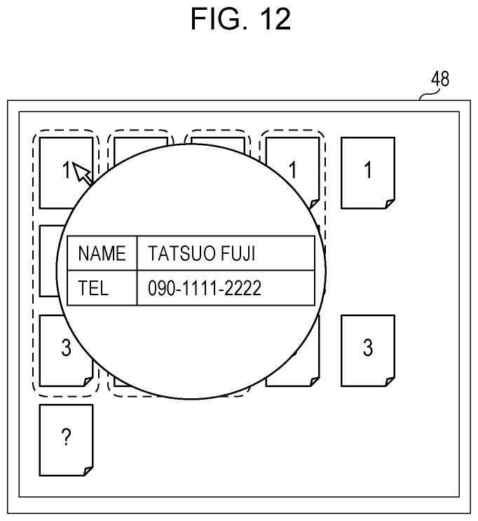

FIG. 12 is a front view illustrating an example of the improper-page-list screen 48 in a state where page contents are displayed in an expanded fashion.

As shown in FIG. 12, when any one of the pages in the second data set on the improper-page-list screen 48 is selected, the CPU 11A may perform control for displaying information indicating the contents of the selected page in an expanded fashion. In this case, a selection is, for example, a mouse-over-based selection.

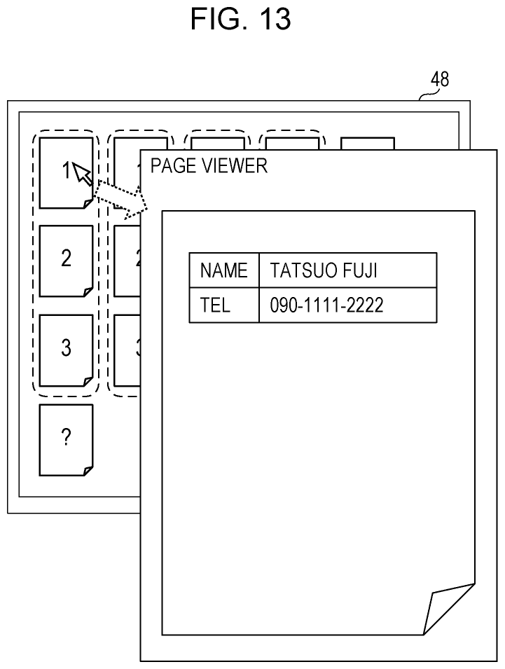

FIG. 13 is a front view illustrating an example of the improper-page-list screen 48 displaying a page viewer.

As shown in FIG. 13, when any one of the pages in the second data set on the improper-page-list screen 48 is clicked, the CPU 11A performs control for displaying information indicating the contents of the clicked page on the page viewer.

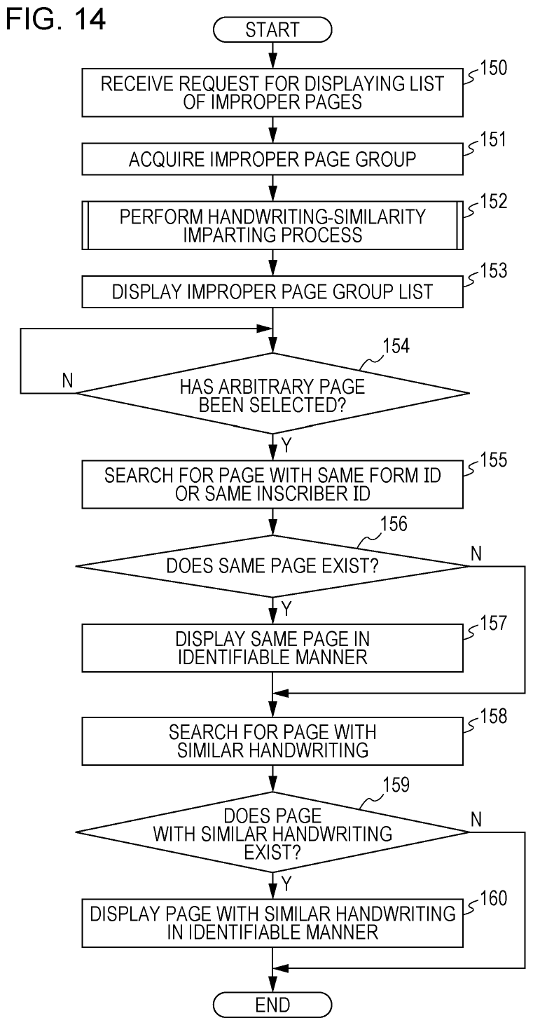

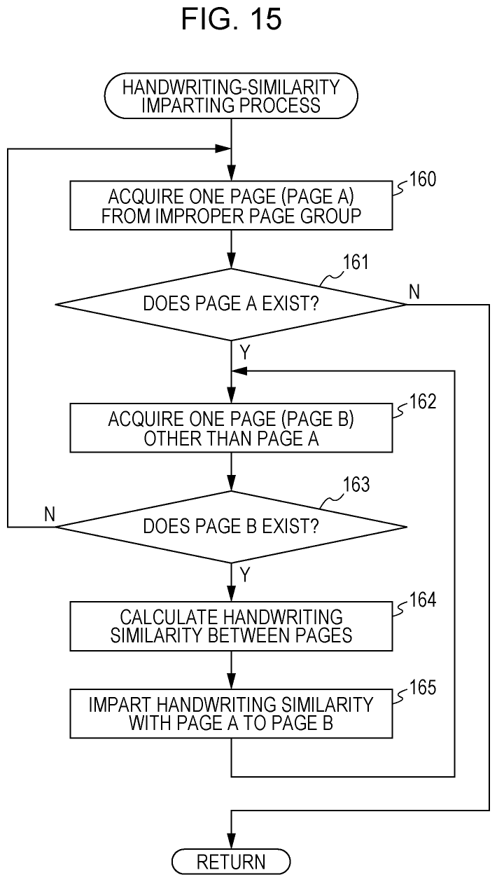

Next, another example of the improper-page-list displaying process will be described with reference to FIGS. 14 and 15.

FIG. 14 is a flowchart illustrating another example of the flow of the improper-page-list displaying process according to this exemplary embodiment.

First, when the server apparatus 10 is commanded to execute the improper-page-list displaying process, the CPU 11A activates the information processing program 12A to execute the following steps.

In step 150 in FIG. 14, the CPU 11A performs control for receiving a request for displaying a list of improper pages from the checker terminal apparatus 40.

In step 151, the CPU 11A acquires an improper page group from the improperness folder.

In step 152, the CPU 11A performs a handwriting-similarity imparting process on the improper page group acquired in step 151.

FIG. 15 is a flowchart illustrating an example of the flow of the handwriting-similarity imparting process according to this exemplary embodiment.

In step 160 in FIG. 15, the CPU 11A acquires one page (referred to as “page A” hereinafter) from the improper page group.

In step 161, the CPU 11A determines whether or not page A exists. If it is determined that page A exists (i.e., if a positive determination result is obtained), the process proceeds to step 162. If it is determined that page A does not exist (i.e., if a negative determination result is obtained), the process returns to step 153 in FIG. 14.

In step 162, the CPU 11A acquires one page (referred to as “page B” hereinafter) other than page A.

In step 163, the CPU 11A determines whether or not page B exists. If it is determined that page B exists (i.e., if a positive determination result is obtained), the process proceeds to step 164. If it is determined that page B does not exist (i.e., if a negative determination result is obtained), the process returns to step 160 and is repeated thereafter.

In step 164, the CPU 11A calculates a handwriting similarity between pages, namely, page A and page B. As mentioned above, the possibility of the handwriting being identical increases with increasing handwriting similarity (indicated with, for example, %).

In step 165, the CPU 11A imparts the handwriting similarity with page A to page B. The process then returns to step 162 and is repeated thereafter.

Referring back to FIG. 14, in step 153, the CPU 11A performs control for displaying an improper-page-list screen as an improper page group list on the checker terminal apparatus 40.

In step 154, the CPU 11A determines whether or not an arbitrary page has been selected from the improper-page-list screen. If it is determined that an arbitrary page has been selected (i.e., if a positive determination result is obtained), the process proceeds to step 155. If it is determined that an arbitrary page has not been selected (i.e., if a negative determination result is obtained), the process enters a standby state at step 154.

In step 155, the CPU 11A searches through the improper page group included in the improper-page-list screen for a page with the same form ID or the same inscriber ID as the page selected in step 154.

In step 156, the CPU 11A determines whether or not a page with the same form ID or the same inscriber ID exists based on the search result obtained in step 155. If it is determined that a page with the same form ID or the same inscriber ID exists (i.e., if a positive determination result is obtained), the process proceeds to step 157. If it is determined that a page with the same form ID or the same inscriber ID does not exist (i.e., if a negative determination result is obtained), the process proceeds to step 158.

In step 157, the CPU 11A performs control for displaying the page with the same form ID or the same inscriber ID in an identifiable manner on the improper-page-list screen. In detail, for example, the color of the relevant page is changed so as to be varied from the color of other pages.

In step 158, the CPU 11A searches through the improper page group included in the improper-page-list screen for a page with handwriting similar to that on the page selected in step 154. For example, a page with a handwriting similarity of 50% or higher is searched for.

In step 159, the CPU 11A determines whether or not a page with similar handwriting exists based on the search result obtained in step 158. If it is determined that a page with similar handwriting exists (i.e., if a positive determination result is obtained), the process proceeds to step 160. If it is determined that a page with similar handwriting does not exist (i.e., if a negative determination result is obtained), the information processing program 12A ends.

In step 160, the CPU 11A performs control for displaying the page with similar handwriting in an identifiable manner on the improper-page-list screen, and the sequential process based on the information processing program 12A ends. In detail, for example, the color of the relevant page is changed so as to be varied from the color of other pages. Furthermore, levels of handwriting similarity may be made identifiable by, for example, setting the color density of a page with a handwriting similarity ranging between 50% and 70% inclusive to 50% and setting the color density of a page with a handwriting similarity ranging between 70% and 100% inclusive to 70%.

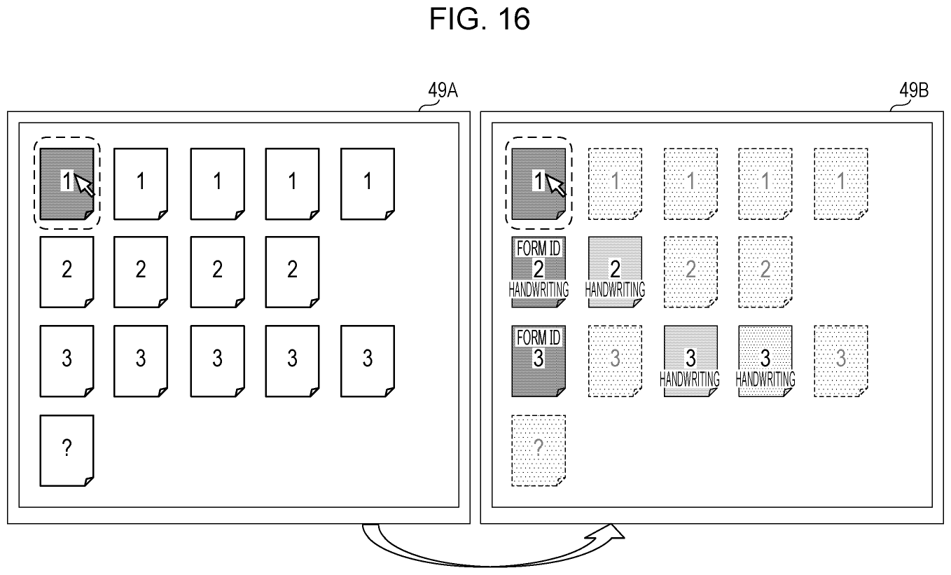

Next, another example of the improper-page-list displaying process will be described in detail with reference to FIG. 16.

FIG. 16 is a diagram used for explaining another example of the improper-page-list displaying process according to this exemplary embodiment.

On an improper-page-list screen 49A in FIG. 16, an arbitrary page is selected. In this case, page 1 at a location (i.e., upper left corner) where the mouse pointer is positioned is selected. On an improper-page-list screen 49B in FIG. 16, the color of pages having the same form ID as selected page 1 is varied from the color of pages with handwriting similar to that on selected page 1. In the example in FIG. 16, the difference in colors is expressed by different hatch patterns.

Specifically, the CPU 11A performs control for displaying candidates for combinations of adequate pages in an identifiable manner, as shown on the improper-page-list screen 49B in FIG. 16. In this case, the CPU 11A may perform the display control by giving meta-information used for searching for pages serving as candidates for adequate combinations to each of the pages. On the improper-page-list screen 49B in FIG. 16, a form ID and handwriting are given as an example of meta-information.

As mentioned above, the CPU 11A performs a process for deriving a handwriting similarity indicating a similarity between the handwriting on the selected page (i.e., page 1 at the upper left corner in the example in FIG. 16) and the handwriting on another page, and performs control for displaying levels of handwriting similarity for pages serving as candidates for adequate combinations in an identifiable manner. On the improper-page-list screen 49B in FIG. 16, the color density is the highest for the highest handwriting similarity, the color density is the lowest for the lowest handwriting similarity, and the color density is at an intermediate level for an intermediate handwriting similarity.

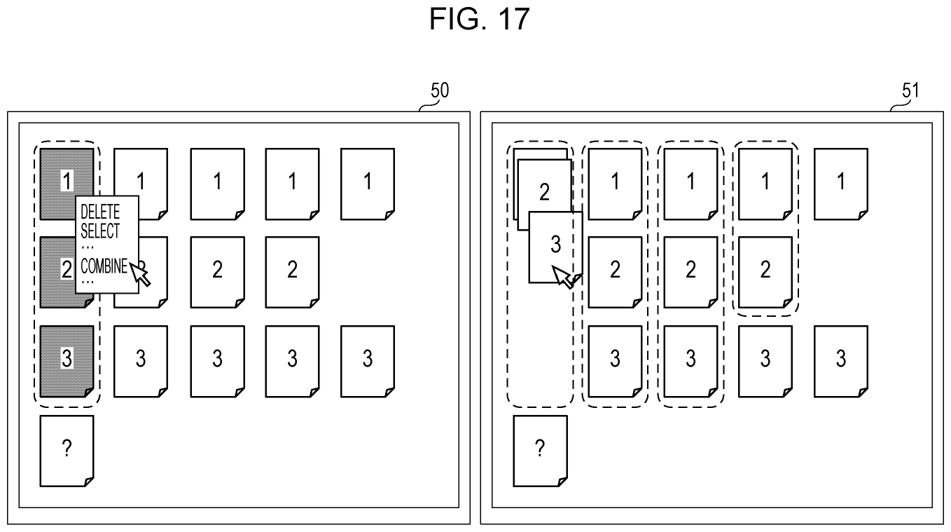

Next, a process for combining adequate pages selected from the improper-page-list screen (referred to as “adequate-page combining process” hereinafter) will be described in detail with reference to FIG. 17.

FIG. 17 is a diagram used for explaining the adequate-page combining process according to this exemplary embodiment.

On an improper-page-list screen 50 in FIG. 17, pages to be combined are selected, and a “combine” option in a right-click menu is selectively operated, so that the selectively-operated page group is combined into one. On an improper-page-list screen 51 in FIG. 17, another page is stacked over pages to be combined in accordance with a drag-and-drop operation, so that the stacked page group is combined into one. The page group is defined as a combined page group.

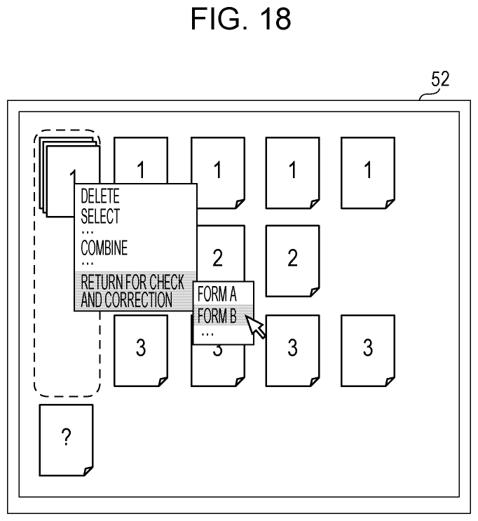

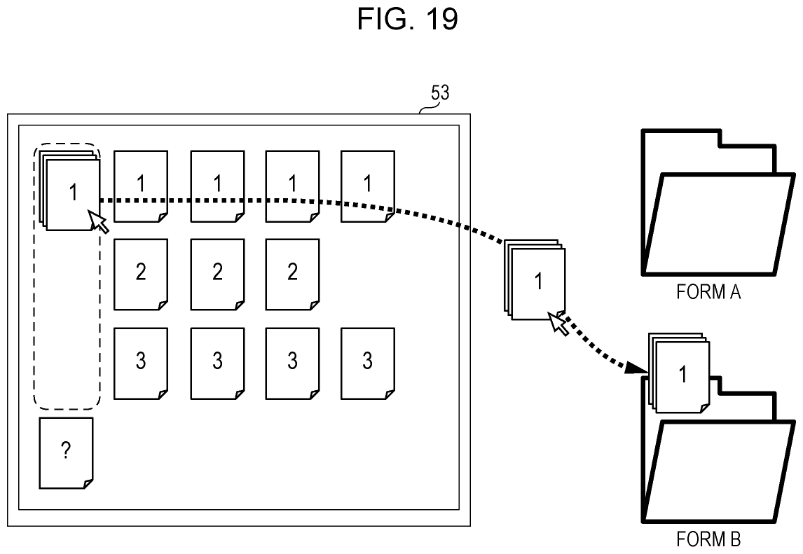

Next, a process for storing the combined page group into a checking-process folder (referred to as “combined-page-group storing process” hereinafter) will be described in detail with reference to FIGS. 18 and 19.

FIG. 18 is a diagram used for explaining the combined-page-group storing process according to this exemplary embodiment.

On an improper-page-list screen 52 in FIG. 18, when an option “return for check and correction” is selected from a right-click menu of the combined page group and an option “form B” as a form serving as a returning destination is selected, the combined page group is stored into a folder for “form B”, so as to be returned for a checking process.

FIG. 19 is a diagram used for explaining another combined-page-group storing process according to this exemplary embodiment.

On an improper-page-list screen 53 in FIG. 19, the combined page group is stored into the folder for “form B”, as a form serving as a returning destination, in accordance with a drag-and-drop operation, so as to be returned for a checking process.

According to this exemplary embodiment, if a combination in a data set obtained by reading and sorting out a document set is improper, the data set containing the improper combination is disassembled and is reassembled into a data set with a proper combination. Therefore, even if a combination in the document set is improper, a data set with a proper combination may be obtained.

In the above exemplary embodiment, information processing executed by the CPU loading a software program may be executed by various types of processors other than the CPU. In this case, examples of the processor include a programmable logic device (PLD) whose circuit configuration is changeable after being manufactured, such as a field-programmable gate array (FPGA), and a dedicated electrical circuit serving as a processor having a circuit configuration specifically designed for executing a specific process, such as an application specific integrated circuit (ASIC). Furthermore, this information processing may be executed by one of these types of processors, or may be executed with a combination of two or more of the same type or different types of processors (e.g., a combination of multiple FPGAs or a combination of a CPU and an FPGA). More specifically, the hardware structure of each of these types of processors is an electrical circuit constituted of a combination of circuit elements, such as semiconductor elements.

A server apparatus has been described above as an example of an information processing apparatus according to an exemplary embodiment. The exemplary embodiment may be in the form of a program for causing a computer to execute the functions of the units included in the server apparatus. The exemplary embodiment may be in the form of a non-transitory computer-readable storage medium storing the program therein.

Furthermore, the configuration of the server apparatus described in the above exemplary embodiment is merely an example, and may be modified in accordance with conditions within the scope of the exemplary embodiment.

Moreover, the flow of the process according to the program described in the above exemplary embodiment is merely an example. An unnecessary step or steps may be deleted, a new step or steps may be added, or the processing sequence may be changed within the scope of the exemplary embodiment.

In the above exemplary embodiment, the program is executed so that the process according to the exemplary embodiment is realized based on a software configuration by using the computer. Alternatively, the exemplary embodiment may be realized in accordance with, for example, a hardware configuration or a combination of a hardware configuration and a software configuration.

In the embodiment above, the term “processor” refers to hardware in a broad sense. Examples of the processor include general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to perform a process including
disassembling each of a plurality of first data sets in units of pages if a combination in the first data set is improper, the plurality of first data sets being obtained by reading and sorting out a plurality of document sets each containing a plurality of pages of documents, and
reassembling an adequate combination as a second data set if a page group obtained as a result of the disassembling includes the adequate combination.

2. The information processing apparatus according to claim 1,
wherein the processor is configured to perform control for displaying a plurality of pages disassembled from the first data set and for displaying information indicating a cause of improperness of the first data set.

3. The information processing apparatus according to claim 2,
wherein the cause involves a page missing from the first data set.

4. The information processing apparatus according to claim 2,
wherein the cause involves an excess page included in the first data set.

5. The information processing apparatus according to claim 4,
wherein the excess page is any one of a redundant page, a page of a different inscriber, and an unknown page.

6. The information processing apparatus according to claim 1,
wherein, if a page is missing from the first data set, the processor is configured to perform a process for storing a plurality of pages in the first data set into a predetermined folder.

7. The information processing apparatus according to claim 2,
wherein, if a page is missing from the first data set, the processor is configured to perform a process for storing a plurality of pages in the first data set into a predetermined folder.

8. The information processing apparatus according to claim 6,
wherein, if the first data set includes an excess page, the processor further performs a process for storing the excess page into the folder.

9. The information processing apparatus according to claim 8,
wherein the processor is configured to perform a process for reassembling a remaining page, excluding the excess page deleted from the first data set, as the second data set.

10. The information processing apparatus according to claim 6,
wherein each page in the page group stored in the folder is given meta-information, and
wherein the processor is configured to perform a process for identifying the adequate combination from the page group by using the meta-information given to each page in the page group, and to perform control for displaying the identified adequate combination as the second data set in an identifiable manner.

11. The information processing apparatus according to claim 8,
wherein each page in the page group stored in the folder is given meta-information, and
wherein the processor is configured to perform a process for identifying the adequate combination from the page group by using the meta-information given to each page in the page group, and to perform control for displaying the identified adequate combination as the second data set in an identifiable manner.

12. The information processing apparatus according to claim 9,
wherein each page in the page group stored in the folder is given meta-information, and
wherein the processor is configured to perform a process for identifying the adequate combination from the page group by using the meta-information given to each page in the page group, and to perform control for displaying the identified adequate combination as the second data set in an identifiable manner.

13. The information processing apparatus according to claim 10,
wherein, if any of pages in the second data set is selected, the processor is configured to perform control for displaying information indicating content of the selected page in an expanded fashion.

14. The information processing apparatus according to claim 6,
wherein each page in the page group stored in the folder is given meta-information, and
wherein the processor is configured to perform a process for searching for a candidate for the adequate combination from the page group based on the meta-information of a page selected from a list of the page group, and to perform control for displaying the searched candidate for the adequate combination in an identifiable manner.

15. The information processing apparatus according to claim 8,
wherein each page in the page group stored in the folder is given meta-information, and
wherein the processor is configured to perform a process for searching for a candidate for the adequate combination from the page group based on the meta-information of a page selected from a list of the page group, and to perform control for displaying the searched candidate for the adequate combination in an identifiable manner.

16. The information processing apparatus according to claim 14,
wherein, when the candidate for the adequate combination is to be displayed in an identifiable manner, the processor is configured to perform display control such that the meta-information used for searching for pages serving as the candidate for the adequate combination is given to each of the pages.

17. The information processing apparatus according to claim 16,
wherein the meta-information includes handwriting, and
wherein the processor is configured to perform a process for deriving a handwriting similarity indicating a similarity between handwriting on the page selected from the list of the page group and handwriting on another page, and to perform control for displaying levels of handwriting similarity for the pages serving as the candidate for the adequate combination in an identifiable manner.

18. The information processing apparatus according to claim 1,
wherein the processor is configured to recognize a plurality of pages of read data obtained by reading each document set so as to acquire meta-information related to each of the plurality of pages, and perform a process for determining whether or not the first data set is improper by using the acquired meta-information.

19. The information processing apparatus according to claim 18,
wherein each of the documents is a form, and
wherein the meta-information is at least one of a page number of the form, a layout, a specific field, an image patch, a form identification, handwriting, and an inscriber identification.

20. A non-transitory computer readable medium storing a program causing a computer to execute a process, the process comprising:
disassembling each of first data sets in units of pages if a combination in the first data set is improper, the first data sets being obtained by reading and sorting out a plurality of document sets each containing a plurality of pages of documents; and
reassembling an adequate combination as a second data set if a page group obtained as a result of the disassembling includes the adequate combination.
